(19) United States
(12) Patent Application Publication
(10) Pub. No.: US 2009/0162470 A1
(43) Pub. Date: Jun. 25, 2009

(54) PROCESS FOR PRODUCTION OF A SCREW FOR AN EXTRUDER, AND SCREW

(76) Inventor: Erwin Schnabl, Wolkersdorf im Weinviertel (AT)

Correspondence Address: K.F. ROSS P.C., 5683 RIVERDALE AVENUE, SUITE 203 BOX 900, BRONX, NY, 10471-0900, US

(21) Appl. No.: 12/304,183

(22) PCT Filed: Jun. 6, 2007
(86) PCT No.: PCT/EP07/55596

§ 371 Date: Dec. 10, 2008

(30) Foreign Application Priority Data
Jun. 16, 2006 (AT) A1031/2006

(51) Int. Cl. B29C 47/38; B23K 31/02

(52) U.S. Cl. 425/209; 228/176; 228/159

(57) ABSTRACT

At least one section of the screw (11) has a wear-protection layer (13) and at least one other section of the screw preferably has an anti-friction layer (18). In a solid rod (11′), abed (12) for the wear-protection layer (13) is first formed, and in this the wear-protection layer (13) is then applied, and finally the interstices (14) between the screw flights (15) are formed. According to the invention, the wear-protection layer (13), for example composed of tungsten carbide, is applied by build-up welding, and the interstices (14) are formed with lateral separation (16, 16′) with respect to the wear-protection layer (13). For production of the anti-friction layer, the dimension of that/those section(s) of the screw (11) where the anti-friction layer, e.g. composed of molybdenum, is to be applied is reduced below specification, while providing lateral separation (19) with respect to the wear-protection layer. The anti-friction layer is then applied in the under-dimensioned region (17). Finally, the screw (11) is brought to the specified dimension.

The present invention relates to a method for making a screw for an extruder, which screw is provided with a wear-protection layer in at least one region where a bed for the wear-protection layer is formed at first in a solid rod in which bed the wear-protection layer is then placed and finally the intermediate spaces between the screw lands are formed. It also relates in particular to a method for making a screw that is additionally provided in at least one other region with a sliding layer. Finally, it also relates to such screws.

### STATE OF THE ART

It is already known from EP 1614502 [US 2006/0007776] that the housing of an extruder can be jacketed with especially wear-resistant material in those regions that are subject to elevated wear. These regions can be limited axially as well as radially. According to EP 1614502, in an oppositely directly double screw extruder those regions are especially critical in the 10 o'clock to 2 o'clock range.

In the axial respect an extruder can be divided into a intake zone, a compression zone, a decompression zone (for degassing, if required) and into a metering zone. It is known from paragraph 25 of EP 1614502 that the wear-resistant material can be applied only in the compression zone and in the metering zone. This is possible in the simplest manner in that the housing is designed in two parts.

Attached FIG. 1 shows such an extruder housing in longitudinal section. The cross section looks like FIG. 7 of EP 1614502. The extruder housing consists of parts 1 and 2 connected to one another by flanges (not shown). Before parts 1 and 2 are connected to each other, wear-resistant material is fitted into part 2 from both ends. The wear-resistant material is shown in FIG. 1 in the form of insert sleeves 3 and 4, that is, not limited radially. However, this is not important—the wear-resistant material could also be present only in certain radial regions such as is shown in FIG. 3 of EP 1614502.

Part 1 of the housing is provided for the intake zone and precompression/preheating zone. Here the material is supplied via a hopper (not shown). The insert 3 is located in the compression zone (where high mechanical wear occurs). The material is melted here. The insert 4 is located in the metering zone (where high chemical stress occurs). Here, the screw ensures a constant volume flow that is then forced through the extruder nozzle. In this illustrated embodiment the decompression zone is located between the inserts 3 and 4. A vacuum is applied to the decompression zone so that the gases escape.

The part 1 usually consists of nitrided steel and is, e.g. 1.6 m long. The part 2 is, e.g. 2.4 m long and is provided with inserts 3 and 4 of (very hard) powder metallurgic steel. The part 2 itself can also consist of nitrided steel.

Screws are usually coated with molybdenum. Molybdenum is a good friction partner for nitrided steel—it acts as a sliding layer; however, it wears very rapidly in the region of the inserts of powder metallurgic steel. Tungsten carbide is, on the other hand, a good friction partner for the powder metallurgic inserts—it acts here as a wear-protection layer but results in rapid wear of nitrided steel. (Since screws are cheaper than the extruder housings, tungsten carbide on the screws in the region of nitrided steel is a very poor solution because the extruder housings must frequently be replaced as a result. It is more advantageous if the screws wear and must therefore be replaced more frequently and the housings consequently last longer.)

In order that screws are suitable for an extruder housing in accordance with FIG. 1, they must be coated differently in axial direction, as is known, e.g., from DE 10161363 [WO 2003/051610]. According to FIG. 2 of this publication, at first a spiral groove is milled in a rod. A strip with the desired layer is fitted into this groove. A heat treatment then takes place as a result of which this strip becomes soldered to the base body. Then, the intermediate spaces between the screw lands are formed. The end effect is that the entire surface of the screw lands are armored by a wear-protection layer or are provided with a slide layer (according to the strip used).

This method has several disadvantages. On the one hand a soldered connection is not a very good connection. Tungsten carbide as wear-protection layer is therefore usually applied on the screw by built-up welding, which yields a significantly better connection (melt composite). A problem in built-up welding is the fact that the material of the screw is greatly heated when it is done, which has the consequence that it is slightly warped. (The requirements placed on the precision of rotation are extremely high because the screws are several meters long and should deviate by a maximum of about 0.1 mm). If the intermediate spaces between the screw lands are then subsequently formed, even the layer of tungsten carbide must obligatorily also be partially removed. However, tungsten carbide is so hard that this is barely possible with metal-cutting machining since the cutting tools become dull extremely rapidly.

In screws comprising different coatings in different regions, there is a further disadvantage in this known method that the coatings must all be equally thick, which is also not optimal: molybdenum as a sliding layer is normally applied with a lesser thickness (e.g. 0.4 mm) than tungsten carbide (e.g. 1 mm) as wear-protection layer.

### SUMMARY OF THE INVENTION

The present invention has the problem of creating a method for making screws that can be readily carried out and nevertheless creates screws that are very true to measure. Furthermore, a method is to be created with which these screws are only partially provided with a wear-protection layer and are coated in the other parts with a sliding layer.

This problem is solved by a method of the initially cited type in accordance with the invention in that the wear-protection layer, e.g. of tungsten carbide, is applied by built-up welding, and that the intermediate spaces are formed at a spacing from the wear-protection layer.

Built-up welding produces a very strong welding connection (a melt composite). As a result of the fact that during the production of the intermediate spaces a lateral spacing to the wear-protection layer is left, the final effect is that the screw land is not entirely coated with the wear-protection layer but rather the wear-protection layer also lies on the finished screw in a bed; thus, it is surrounded laterally by material of the base body of the screw. This is not problematic when the screw is being used and has the manufacturing advantage that the wear-protection layer, e.g. of tungsten carbide, does not have to be laterally worked mechanically and a sharp edge is nevertheless obtained.

The manufacture of the intermediate spaces takes place best by a procedure designated as “whirling.” With it, a cutter head is moved around the screw to be manufactured. This is substantially more economical than milling, but extremely hard coatings can be worked only poorly with this method.

As already mentioned, some extruder housings require that the screw be coated differently in different regions. In addition to a wear-protection layer, a slide layer is also frequently necessary that is supposed to reduce wear of the housing in the unhardened housing regions. Such a slide layer, e.g. of molybdenum, is applied for example by thermal spraying with a plasma method. Thus the base material warms up only moderately (e.g. to 150° C.), so that there is no danger that the screw warp. No melt composite is produced during thermal spraying, in contrast to built-up welding, but the adhesion is nevertheless sufficient.

The location where the slide layer borders on the wear-protection layer is problematic. As a result of the built-up welding (PTA welding) the base material of the screw is mixed, for example, with carbides, as a result of which the slide layer does not adhere well at this position and readily breaks away. Moreover, the slide layer is as a rule significantly thinner, e.g. only half the thickness of the wear-protection layer. A continuous bed as provided in DE 10161363 is for these reasons not optimal.

For this reason an embodiment of the invention provides that, when a slide layer is provided in at least one other region of the screw, the screw is machined down according to the method steps of claim 1 in the region or in the regions where the slide layer, e.g. of molybdenum, is to be applied, during which, however, a lateral spacing to the wear-protection layer is maintained, the slide layer being applied thereafter in the machined-down region and the screw finally being brought to the theoretical size.

The bed is therefore provided, in contrast to DE 10161363 at first only in the region in which the wear-protection layer is to be applied. After this has taken place and the intermediate spaces between the screw lands have been produced, the screw is machined down in the regions where the slide layer is to be applied. (This can be achieved, as will still be explained, at least partially again by the provision of a bed that does not, however, have to have the same depth as the bed of the wear-protection layer). However, this is not performed immediately up to the wear-protection layer but rather only up to a certain minimal spacing (e.g. 2 mm) from the latter. The slide layer is applied in the regions in which the screw now has been machined down. As a result of the minimum spacing to the wear-protection layer the slide layer does not contact the carbides so that there is no danger that the slide layer will break away at this position. Moreover, there is a clean step at the end where the slide layer rests laterally, which additionally improves adhesion. After the slide layer has been applied, the entire screw is ground to the theoretical size.

It is advantageous if the screw is nitrided after the application of the wear-protection layer and before the screw is machined down for the application of the slide layer. This has two advantages: on the one hand nitriding is desired for the screw flanks and the screw base; on the other hand the slide layer adheres poorly to nitrided material. As a result of the fact that the screw is machined down after nitriding, the nitrided layer is removed at these positions (thus, on the head of the screw lands) so that the slide layer adheres well here; the slide layer can be removed more readily from the other regions (where no slide layer is desired).

It is also possible as an alternative to or also additionally to the nitriding to mask regions of the screw onto which no slide layer is to be applied. Even this hinders the adhesion of the slide layer on the screw material so that it can be readily removed.

In the method described up to now the slide layer has a corner with an acute angle on the front side facing the wear-protection layer. Such corners possibly break away when the screw is subjected to extremely high stresses. In order to avoid this, it can be provided that a bed with a lateral land is milled for the slide layer at least in the region adjacent of the region with the wear-protection layer, so that the base of the bed is undersized. In this manner there is a bed with a rounded corner (the rounding corresponds to the radius of the milling apparatus) in this critical region and moreover the corner of the slide layer is surrounded on both sides by the base material of the screw.

Screws of the above-described type in accordance with the invention are characterized in that the slide layer, e.g. of molybdenum, has a lateral spacing from the wear-protection layer, e.g. of tungsten carbide. This lateral spacing reduces the danger that the slide layer breaks out. It is furthermore advantageous here if the sliding region is surrounded in a bed in the end region facing the wear-protection layer and has a rounded corner.

### BRIEF DESCRIPTION OF THE DRAWINGS

The invention is explained in detail using the attached drawings.

FIG. 1 shows a housing of an extruder with different regions;

FIG. 2 shows the base body of a screw with a milled-in bed for a wear-protection layer;

FIG. 3 shows this base body with the wear-protection layer fitted in this bed;

FIG. 4 shows this base body after the intermediate spaces between the screw lands have been formed;

FIG. 5 shows this screw after the screw had been machined down adjacent the wear-protection layer;

FIG. 6 shows the finished screw;

FIG. 7 shows a variant of FIG. 5; and

FIG. 8 shows the variant corresponding to FIG. 6.

### BEST MODE FOR CARRYING OUT THE INVENTION

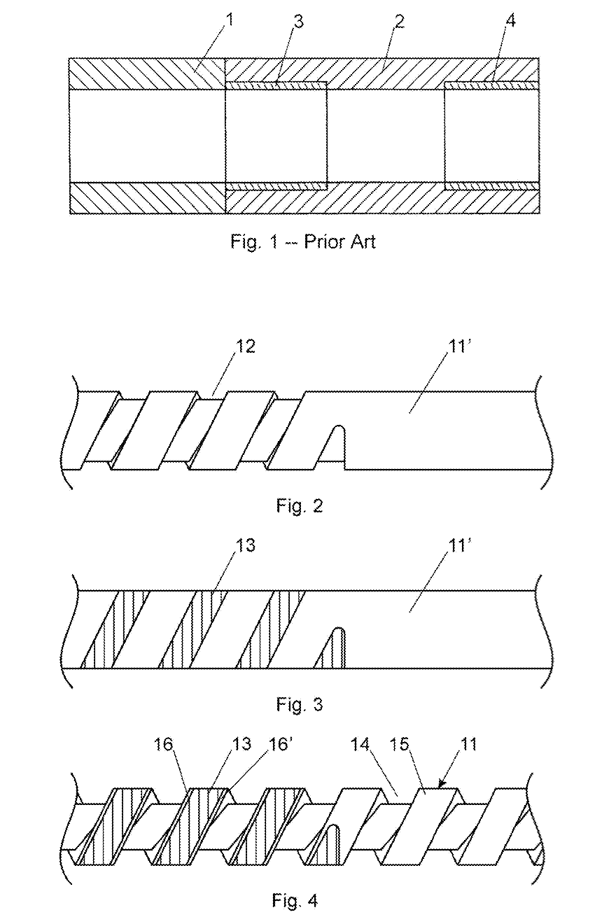

The extruder housing according to FIG. 1 consists of the parts 1 and 2 connected to one another by flanges (not shown).

Before the two parts 1 and 2 are connected to one another, the wear-resistant material is fitted in the part 2 from both ends. The wear-resistant material is shown in FIG. 1 in the form of insert sleeves 3 and 4.

A screw is to be coated in the region of the inserts 3 and 4 with a wear-protection layer, e.g. with tungsten carbide, but in the remaining regions with a slide layer, for example, with molybdenum.

The manufacture of such a screw is explained using FIG. 2 to 6. In these figures an axially extending portion of the screw (and of the base body of the screw) is shown where the transition from tungsten carbide to molybdenum is or should be located.

At first, a bed groove 12 is milled into the cylindrical base body 11′ of the screw, only in the region where the wear-protection layer is to be subsequently fitted. Then, a wear-protection layer 13 is made by built-up welding in this bed 12 (see FIG. 3). The built-up welding can be done manually but in the case a rather large series a welding robot can naturally also be used.

Since a rough surface results during the built-up welding, more wear-protection layer is applied than is necessary and it is later ground down to the desired finish size. E.g. 1.5 mm tungsten carbide is applied and ground down to 1 mm.

In order that this can be readily possible, it is advantageous to first manufacture the screw 11 with an appropriate oversize (thus, e.g. +0.5 mm for the radius) and also to manufacture the bed correspondingly deeper, thus, e.g. 1.5 mm. Then the entire bed can be filled during the built-up welding.

(Note: the depth of the bed 12 is not true to scale in FIG. 2 but rather greatly exaggerated in order to make the drawing clearer.)

Next, recesses 14 are formed (see FIG. 4) between the screw lands 15. This produces a screw 11 from the base body 11′. Care is to be taken that a spacing should remain between the recesses 14 and wear-protection layer 13 so that a narrow strip 16 and 16′ of the base material of the screw remains on both sides of the wear-protection layer 13. This is advantageous from an engineering standpoint because the wearing off of the wear-protection layer would result in a severe wear of the tool.

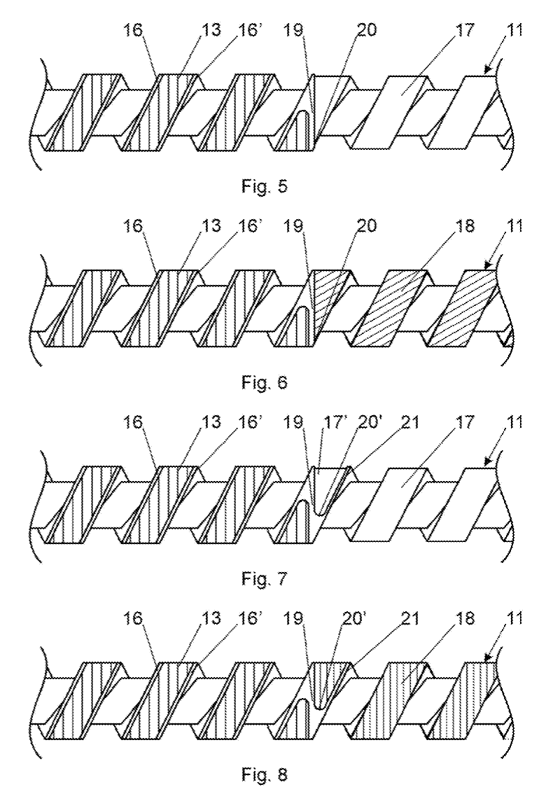

The screw 11 is now ground in region 17 (see FIG. 5), where the slide layer is to be applied, to undersize it (e.g. by 0.4 mm). The undersize should be exactly as large as the desired thickness of the slide layer. Care is to be taken that a spacing to the wear-protection layer 13 is left here, so that a land 19 is formed.

Finally, the slide layer 18 (see FIG. 6) is applied in this region 17. Here too more is applied again than is necessary (e.g. 0.5 mm-0.6 mm) and the material is then ground to the desired size (e.g. 0.4 mm).

The grinding to the theoretical size advantageously takes place as the last step for the entire screw.

It is advantageous in the screw according to FIG. 6 that the slide layer 18 is separated from the wear-protection layer 13 by the land 19 consisting of the base material of the screw 11. Thus, the slide layer 18 does not make contact with carbides, so that adhesion cannot be adversely affected by the carbides. Furthermore, the slide layer 18 is located offset axially from the land 19, so that even this improves the adhesion.

FIGS. 7 and 8 show a variant of FIGS. 5 and 6. In the screw according to FIG. 6, a corner 20 that has an acute angle could be problematic. Such corners readily break out. Therefore, according to FIG. 7 at first a bed 17′ is milled (e.g. over half a screw circumference), whose base has the desired undersize. A lateral land 21 is left standing and a rounded corner 20′ necessarily results (by the radius of the milling apparatus). As a result, even the slide layer 18 has a rounded corner 20′ (see FIG. 8) that is surrounded by the base material of the screw and is very well protected in this manner from breaking out.

1. A method for making an extruder screw having a wear-protection layer in at least one region, in which a bed for the wear-protection layer is formed at first in a solid rod, the wear-protection layer is then placed in the bed and finally the intermediate spaces between the screw lands are formed wherein that the wear-protection layer, e.g. of tungsten carbide, is applied by built-up welding, and that the intermediate spaces are formed at a spacing from the wear-protection layer.

2. The method according to claim 1 wherein when a slide layer is provided in at least one other region of the screw the screw is machined down after the method steps of claim 1 in the region or in the regions where the slide layer, e.g. of molybdenum, is to be applied, during which, however, a lateral spacing to the wear-protection layer is maintained, that the slide layer is applied thereafter in the region with the undersize and that the screw is finally brought to the theoretical size.

3. The method according to claim 2 wherein the screw is nitrided between the method steps of claim 1 and 2.

4. The method according to claim 2 or 3 wherein regions of the screw on which no slide layer is to be applied are masked before the method steps of claim 2.

5. The method according to one of claims 2 to 4 wherein a bed with a lateral land is milled for the slide layer at least in the region following the region with the wear-protection layer, so that the base of the bed has the undersize.

6. An extruder screw having at least in one region a wear-protection layer and is provided in at least one other region with a slide layer wherein the slide layer, e.g. of molybdenum, is set at a spacing from the wear-protection layer, e.g. of tungsten carbide.

7. The screw according to claim 6 wherein the sliding region is surrounded in a bed in the end region facing the wear-protection layer and has a rounded corner.

8. A method of making an extruder screw, the method comprising the steps of sequentially:
machining in an outer surface of a cylindrical rod a first helicoidal bed groove having a plurality of turns;
filling the groove by built-up welding with a layer of a wear-resistant material;
machining between the turns of the first groove in the outer surface a second helicoidal groove extending along but spaced from the layer of wear-resistant material such that strips of a base material of the rod flank the layer of wear-resistant material.

9. The method defined in claim 8 wherein the wear-protection layer is of tungsten carbide.

10. The method defined in claim 8 wherein the second groove extends along a first portion and a succeeding second portion of the rod, the wear-resistant material only being applied to the groove in the first portion of the rod, the method further comprising the steps of:
cutting down the turns of the second portion of the rod;
applying a low-friction slide material to the cut-down turns of the second portion of the rod with the slide material ending at a spacing from the wear-resistant material; and
cutting down the rod in the first and second portions such that outer surfaces of the wear-resistant material, of the strips flanking the wear-resistant material, and of the slide material are all flush.

11. The method defined in claim 10, further comprising the step after forming the second groove and before applying the slide material of
nitriding the rod.

12. The method defined in claim 10 wherein the slide material is molybdenum.

13. The method defined in claim 10 wherein the turns of the second portion of the rod are formed by cutting a third groove in the turns in the second portion, the slide material being applied to the third groove.

14. An extruder screw comprising:
an elongated rod formed with a helicoidal groove forming a succession of raised turns;
a layer of a wear-resistant material on the turns in a first portion of the rod; and
a layer of a slide material on the turns in a second portion of the rod spaced longitudinally from the first portion.

15. The extruder screw defined in claim 14 wherein the wear-resistant material is tungsten carbide and the slide material is molybdenum
